(19) United States
(12) Patent Application Publication
(10) Pub. No.: US 2002/0120931 A1
(43) Pub. Date: Aug. 29, 2002

(54) Content based video selection

(76) Inventors: Thomas Huber, Parker, CO (US); Ian Zenoni, Highlands Ranch, CO (US)

Correspondence Address: The Law Offices of William W. Cochran, LLC, Suite 230, 3555 Stanfort Road, Fort Collins, CO, 80525, US

(21) Appl. No.: 10/080,996

(22) Filed: Feb. 20, 2002

Related U.S. Application Data
(60) Provisional application No. 60/270,419, filed on Feb. 20, 2001.

(51) Int. Cl. H04N 7/025; H04N 7/10

(52) U.S. Cl. 725/34; 725/32

(57) ABSTRACT

Disclosed is a system and method that dynamically selects a displayed version of a program from a plurality of broadcast versions. A receiving unit processes a broadcast signal containing a plurality of versions of a program and one version of said plurality of versions is selected. Version selection may reflect stored preference information or information entered through an input device such as remote control or mouse. Broadcast of programs with multiple versions may employ scheduling of programs such that multiple versions of two or more programs do not exceed the number of available channels, or to limit the number of channels required to a specified number. Advertising may be scheduled to delay presentation of a program to limit the number of channels required. Advertising may also be selected employing viewer preference information. The versions made available to viewers may reflect viewer requests, broadcast system capabilities, and revenue generated.

### CROSS REFERENCE TO RELATED APPLICATIONS

This application is based upon and claims the benefit of U.S. Provisional Application No. 60/270,419, entitled “CONTENT BASED VIDEO SELECTION”, filed Feb. 20, 2001 by Thomas Huber, the entire disclosure of which is specifically incorporated herein by reference for all that it discloses and teaches.

### BACKGROUND OF THE INVENTION

a. Field of the Invention

The invention pertains to the selection of broadcast video programming and more specifically to selecting different versions of one or more video programs.

b. Description of the Background

Broadcast television programs are tailored to appeal to some target audience.

In the early evening, for example, programs may be targeted for an 11 to 13 year old audience. The content of such a program may not appeal to older audiences. Similarly, programs directed to other types of audiences may contain scenes that are objectionable to some viewers, such as strong language, violence, smoking, drug use, or nudity, for example. Because of this type of targeted programming, television viewers have a limited choice. As a result, viewers may watch a program with objectionable content, change to a different program or turn the television off when objectionable scenes are presented.

When viewers choose not to watch programs, the viewing audience is diminished, resulting in lower program ratings and lower advertising revenue. Programs that experience lower program ratings and lower advertising rates may be canceled or may be further constrained in terms of production costs.

Further, most programs are presented with a single viewpoint. Programs such as sporting events are typically presented with a single perspective. For example, football game coverage usually centers on the offensive team. Similarly, automobile racing coverage may focus on a group of cars that are leading the race, or coverage of tennis matches may focus on the server.

Further yet, foreign films or foreign language programming may be presented without translation or subtitles. Foreign news programs are often presented without translation or subtitles.

Additionally, single viewpoint broadcasts do not provide an opportunity for viewer interaction. Educational and entertainment programs have a limited format of lecture or presentation.

In order to provide increased viewer enjoyment, by providing a choice of broadcast program perspective or by providing viewer interaction, a method of providing viewers a choice of programs providing content, commentary, perspectives or interaction tailored to the preferences of the viewer is needed. This need also extends to increasing viewer enjoyment and thereby increasing program ratings, revenue, profits and ultimately production budgets such that higher quality programming may be affordably produced.

### SUMMARY OF THE INVENTION

The present invention overcomes the disadvantages and limitations of the prior art by providing a method whereby broadcasters may determine versions to broadcast and viewers may select program content, commentary, or a perspective that reflects their tastes from a plurality of versions of a broadcast video program. A broadcaster may desire to limit the number of channels required to broadcast multiple versions of programs and may elect to limit the number of versions broadcast based on viewer request rate, revenue generated, or other criteria. Requests may be received and processed and most requested versions broadcast.

The present invention may therefore comprise a method of managing broadcast of a program containing a plurality of versions comprising: indicating that a plurality of versions of the program are available to viewers, receiving requests from a plurality of the viewers for at least two versions of the plurality of versions of the program, selecting at least two versions of the plurality of versions of the program, and broadcasting the at least two versions of the plurality of versions of the program.

Advantages of the present invention include scheduling and allocation of channels supporting multiple versions of two or more programs such that the required number of channels may be minimized, providing effect use of broadcast resources.

The present invention may further comprise a method for broadcasting a first program containing multiple versions and a second program containing multiple programs comprising: determining the time and duration when multiple versions occur for the first program and for the second program, determining a first maximum number of channels utilized by the first program when multiple versions occur, determining a second maximum number of channels utilized by the second program when multiple versions occur, and determining a start time for each program such that a period of time when said first program employs the first maximum number of channels does not coincide with a time when the second program employs the second maximum number of channels.

The present invention may additionally comprise a method for selecting a displayed version of a broadcast program containing a plurality of versions comprising: transferring viewer preference information from a receiving unit to receiver associated with the broadcast of the broadcast program, storing the viewer preference information in the receiver, receiving a broadcast signal comprising at least two versions of the plurality of versions of the program, accessing the viewer preference information, obtaining version information from the broadcast program, and selecting one version of the at least two versions employing the viewer preference information.

In addition to selection of content based on viewer preference, advertising may be selected employing viewer preference. This may be employed, for example, to target advertising to a demographic associated with groups that select various ratings, outcomes, languages, and the like.

The present invention may further yet comprise a method for presenting advertising in conjunction with the broadcast of a program comprising a plurality of versions, the method comprising: broadcasting the plurality of versions of the program wherein the broadcast includes an identifier of each version of the plurality of versions of the program, determining a first characteristic of a first version of the plurality of versions of the program, the first version having a first identifier, associating an advertisement with the first characteristic, and broadcasting the advertisement including the first identifier.

The present invention also provides a method for interaction as may be employed in educational programs and entertainment such as game shows. The plurality of versions of a program may be part of a single stream, as may be the case in digital streaming video, or may be presented on different channels. Information contained within the video stream, blanking interval, or transferred prior to transmission of a video program, identifies the available versions of a program and provides sufficient information to enable control and selection of versions by receiving equipment.

The present invention may therefore additionally further comprise a system for selecting a displayed version of a program from a broadcast comprising a plurality of versions of the program, the system comprising: a receiving unit that displays a list of the plurality of versions of the program, a communications unit contained in the receiver that transmits a viewer preference indicating one version of the plurality of versions to a receiver associated with the broadcast of the program, a memory that stores the viewer preference in the receiving unit, a receiver in the receiving unit that receives a broadcast program comprising at least two versions of the plurality of versions of the program, and a selection unit in the receiving unit that selects one version from the at least two versions of the program and displays the one version.

### BRIEF DESCRIPTION OF THE DRAWINGS

In the figures,

FIG. 1 illustrates selection of a displayed channel from a plurality of broadcast channels.

FIG. 2 illustrates channel selection employing a version menu and viewer preferences.

FIG. 3 depicts an analog receiving unit that provides selection among a plurality of versions employing viewer preference information.

FIG. 4 depicts an analog receiving unit employing pre-stored version information.

FIG. 5 is a representation of a digital broadcast signal.

FIG. 6 depicts a digital receiving unit employing stored viewer preferences.

FIG. 7 depicts a digital receiving unit employing pre-stored version information and digital broadcast.

FIG. 8 depicts a digital receiving unit employing an external interface.

FIG. 9 depicts the coincidence of multiple versions for multiple programs.

FIG. 10 depicts advertising insertion to constrain the number of channels required to simultaneously broadcast a plurality of programs with multiple versions.

FIG. 11 illustrates the utilization of available channels to provide multiple versions of advertising.

FIG. 12 depicts utilization of available channel intervals for downloads.

FIG. 13 depicts a method for broadcasting multiple versions of a program.

### DETAILED DESCRIPTION OF THE INVENTION

The present invention is directed to the transmission, reception, and selection of one or more programs comprising multiple versions wherein the broadcast of individual programs may be time aligned to limit the number of channels needed to support the sum of versions for all programs. Advertising may be associated with versions of a program. Broadcast refers to methods of signal distribution including cable, Internet, satellite and standard airwave transmission using analog or digital signals.

Broadcast of video information in digital format may employ coding methods such as QAM (quadrature amplitude modulation) or QPSK (quadrature frequency shift keying). These methods provide encoding of digital data into an analog signal and may employ both amplitude and phase modulation relative to a carrier frequency. For example, some present QAM implementations provide eight digital bits per hertz of carrier frequency. As such, the 6 MHz bandwidth of a NTSC (National Television Standards Committee) analog television channel may be employed to support a plurality of digital channels of television display data.

In accordance with the present invention, a broadcast signal comprising a plurality of digital channels is received. Content information contained within the plurality of channels, or received separately prior to broadcast, identifies the nature of the content of each channel. Content information may include ratings as commonly used by the motion picture industry, providing ratings such as R, G, PG-13, and X, for example. Content information may also provide a description of why a rating is associated with a particular version of a program or portion of a version of a program, such as ‘contains violence, ‘language’ and ‘nudity’, for example. Viewer preference information is used to select among the plurality of digital channels to produce a displayed program comprised of a first channel with segments of other channels conditionally replacing segments of the first channel. All channels need not be active simultaneously. A single channel may be active when a segment of a program is the same for all versions of the program.

In contrast to stored digital video formats such as DVD, that may provide levels of parental authority and selection of different stored program versions, the present invention manages a plurality of broadcast video channels. Information describing the content of a channel may be contained within one or more channels. Analog channels may contain information in the horizontal or vertical blanking interval. Digital channels may contain information in the headers of transferred data blocks. This information may comprise a marker that identifies the beginning or end of a segment, and a tag that provides a content descriptor for the segment. The generation and use of tags and markers is more fully disclosed in U.S. Nonprovisional Patent Application No., entitled “VIDEO TAGS AND MARKERS”, filed Feb. 12, 2002 by Ian Zenoni; and by U.S. Nonprovisional Patent Application No. 09/933,928, entitled “iSELECT VIDEO”, filed Aug. 21, 2001 by Steven Peliotis et al, both of which are specifically incorporated herein by reference for all that they disclose and teach. The present invention monitors the broadcast signal for marker and tag information. Information may be contained in one channel, each channel, or every channel of a group of channels that contain versions of one program. When information is contained within one channel, descriptions of other channels are also contained with in the one channel. When information is contained within each channel, each channel contains marker and tag information for that channel. When information is contained within every channel, every channel contains information about all other channels.

The different methods of storing segment and content information in the broadcast signal suggest different architectures for the receiving unit of the present invention. One embodiment employs a receiving unit that is capable of monitoring a plurality of channels for segment and content information and is capable of generating a display output from any channel, corresponding to a format where each channel contains segment and content information for that channel. A simpler embodiment monitors one channel for segment and content information and is capable of generating a display output from the monitored channel or one other channel, corresponding to the format where one channel contains information about all channels. A simpler embodiment monitors only one channel and generates a display output from that channel, corresponding to the format where segment and content information for all channels is contained in all channels.

By monitoring the segment and content information, the invention is able to compare available versions to viewer preference information to allow selection of one of the plurality of channels for display. In an alternative embodiment, wherein content information is received separately prior to broadcast, the invention monitors the play time of each segment and then selects a version provided in one channel in response to viewer preference information and content information.

As previously mentioned, all channels may not be simultaneously active. As such, channels that are not being used to provide a version of a first program may be used to provide a version or versions of a second program. By selecting two or more programs such that periods of time when multiple versions occur that do not overlap, a fixed number of channels may be used to present two or more programs. This method allows more programs to be presented using broadcast resources, thereby offering greater viewer choice and the opportunity for greater advertising revenue. Further, advertising may be scheduled at different times than a program or such that the number of versions of programs and advertising do not exceed the number of available channels. For example, if two programs have multiple versions occurring at the same time when broadcast simultaneously, an advertising segment with a fewer number of versions may be inserted, thereby delaying broadcast of one or more of the programs until a time when fewer versions are present. Similar to broadcast television, inserted material may comprise advertising, news, program promotions or other material.

The invention may provide an on-screen display to show information such as the current version selection and the existence of other versions. On-screen display may also be employed in an interactive manner. An interactive program, such as a trivia game, may display a list of answers from which the viewer may choose. Choosing an answer may result in automatic selection of a different channel. The viewer may be informed if the answer chosen is correct and possibly an explanation of the correct answer.

Viewer preferences may be used to select versions of video coverage and commentary for a sporting event. Further, the invention may also be employed to allow different versions of a program that have different plots. There may be a choice of story line, or partial elements thereof such as romantic, religious, or happy ending, for example. The invention may also be employed for mystery style programs where the viewer may select where to search for clues to solve the mystery. Additionally, the invention may be used to select the type of material presented. For example, a travel program may provide a plurality of channels with one channel describing the history of the area and another channel describing food or music of the area.

Viewer preference may also be extended to advertising. Different advertisements may be shown on different version channels to reflect viewer preferences. If a viewer has selected a food version for a travel program, advertising may accentuate food or cooking items. Similarly, if a selected program version is suitable for children, advertising directed to younger families may be presented.

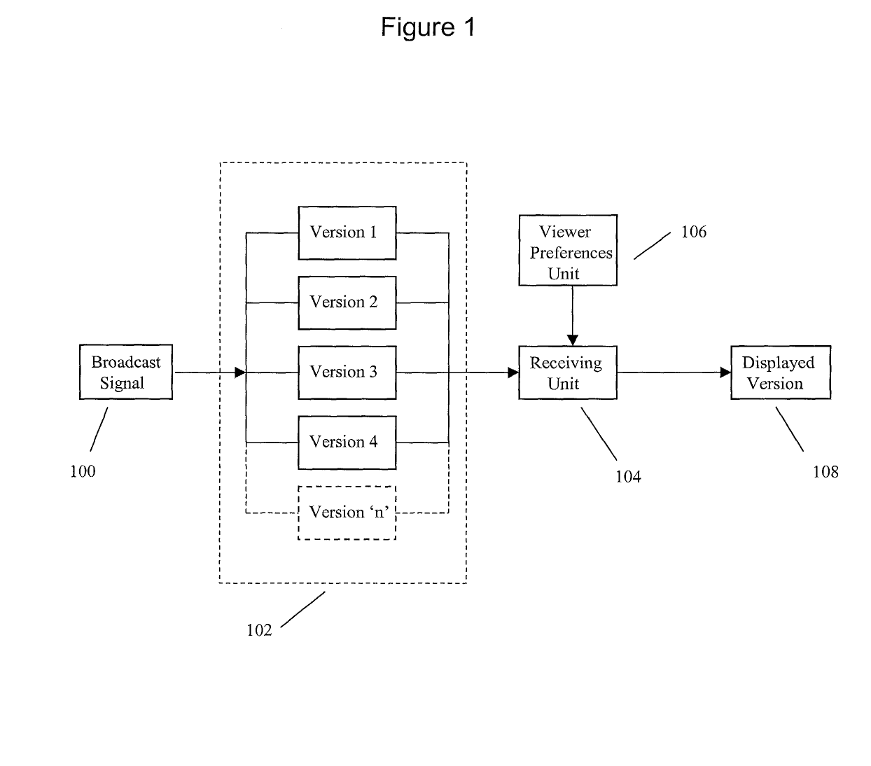

FIG. 1 illustrates the manner in which a particular version of a program or advertising may be selected from a plurality of versions. Broadcast signal 100 comprises a plurality of channels containing versions 102 of a program. Receiving unit 104 monitors at least one channel to obtain segment and content information. Using information from viewer preferences unit 106, receiving unit 104 selects one version to produce the displayed version 108. Preferences stored in viewer preferences unit 106 may be selected using a set top box or remote control to choose one of a number of predefined selections, or may be selected from available versions of a displayed program.

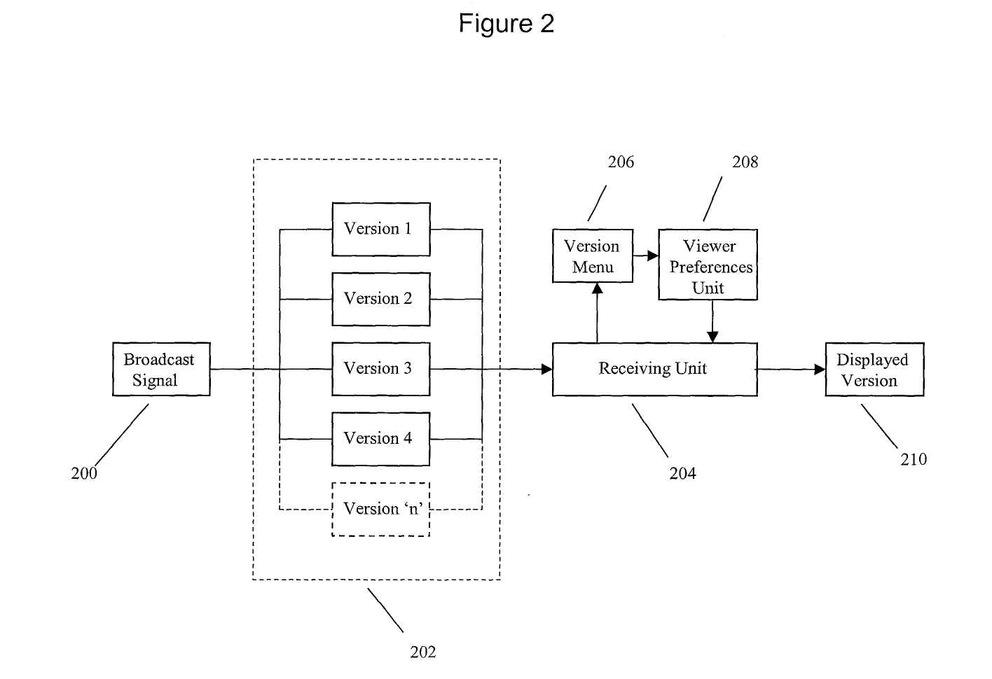

FIG. 2 illustrates channel selection employing a version menu and viewer preferences. Broadcast signal 200 comprises a plurality of channels containing versions 202 of a program. Receiving unit 204 monitors at least one channel to obtain segment and content information. Version menu 206 provides a list of available versions to the viewer. Information describing a version or multiple versions may be stored in viewer preferences unit 208. Receiving unit 204 employs information from viewer preference unit 208 to select one version of the plurality of versions 202 to produce the displayed version 210.

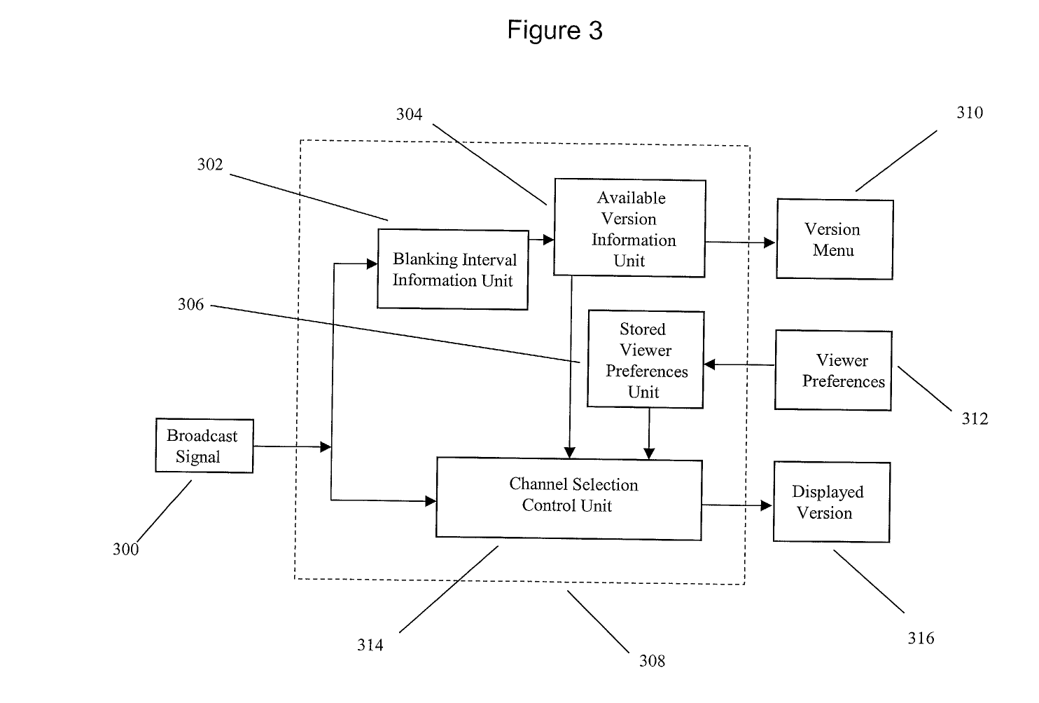

The present invention is applicable to both analog and digital broadcast programs. FIG. 3 depicts an analog receiving unit that provides selection among a plurality of versions employing viewer preference information. Receiving unit 308 comprises blanking interval information unit 302, available version information unit 304, stored viewer preferences unit 306 and channel selection control unit 314. Broadcast signal 300 comprises a plurality of channels and is transmitted to channel selection control unit 314 and blanking interval information unit 302. Blanking interval information 302 obtains program information from the blanking interval of broadcast signal 300 and stores the program information in available version information unit 304. Available version information unit 304 may be used to create version menu 310. A viewer may select a version to create viewer preferences 312. Information from viewer preferences 312 may be stored in stored viewer preferences unit 306. Stored viewer preferences unit 306 and available channel information unit 304 are input to channel selection and control unit 314. Channel selection and control unit 314 processes available version information and stored viewer preferences to select and output displayed version 316 that reflects viewer preferences. For example, if the preferences in stored viewer preferences 306 are for PG-13 rated versions, but only PG and NC-17 versions are available, the channel selection control unit 314 may select the PG version. As previously mentioned, blanking interval information unit 302 may monitor one or more channels depending on the format of broadcast signal 300. The architecture of blanking interval information unit 302 may be similar to closed caption processors and processors used by television networks wherein program information is contained in the blanking interval. Although exact encoding and data formats may differ from closed captioning or network processors, methods used to produce a blanking information unit 302 are known to those skilled in the art.

Information defining channel versions may be supplied prior to broadcast of a program or segments or a program using a broadcast signal or other methods of information transfer such as the Internet, for example, to provide pre-stored version information. The pre-stored version information may contain descriptors describing the versions available, duration of version segments, and channel identifiers for available segments. For analog implementations, the descriptors may include program presentation time in a manner consistent with that used for advertising insertion coordination. Digital implementations may include data block identifiers.

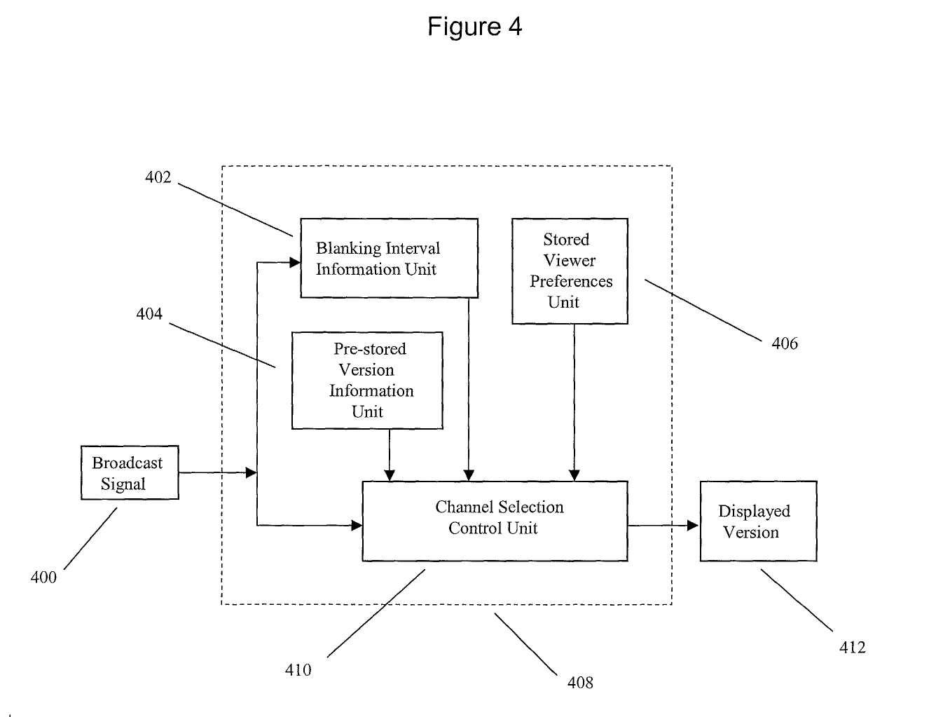

FIG. 4 depicts an analog receiving unit employing pre-stored version information. Broadcast signal 400 comprises a plurality of channels and is input to channel selection control unit 410 and blanking interval information unit 402. Pre-stored version information unit 404 is loaded with version information prior to transmission of the program or segments of the program. Stored viewer preferences unit 406 contains viewer preferences that may be entered through a remote control device, on-screen menu or other method. Blanking interval information unit 402 obtains program information from the blanking interval of broadcast signal 400 and presents it to channel selection control unit 410. Channel selection unit 410, also receives signals from pre-stored version information unit 404 and stored viewer preferences unit 406. Channel selection unit 410 selects and outputs displayed version 412 in response to program information, viewer preferences, and pre-stored version information.

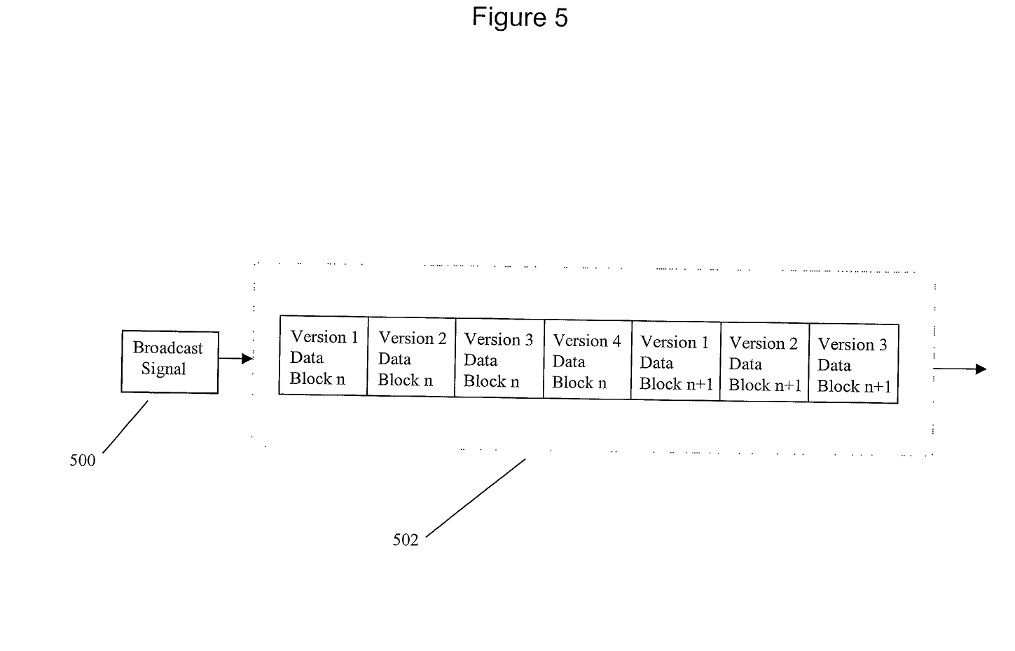

Programs and advertising may employ digital formats. A digital broadcast may conform to MPEG-2/DVB standards and may employ a multiple channels per carrier (MCPC) format, wherein packets for a plurality of channels are multiplexed into the broadcast signal. The number of channels per carrier depends upon the carrier bandwidth and the encoding format employed as is described in greater detail later. FIG. 5 is a representation of a digital broadcast signal stream 500 comprised of data blocks 502 wherein successive data blocks provide data for each channel version. Data blocks 502 contain header information identifying channel and display time information such that audio may be synchronized with the displayed picture.

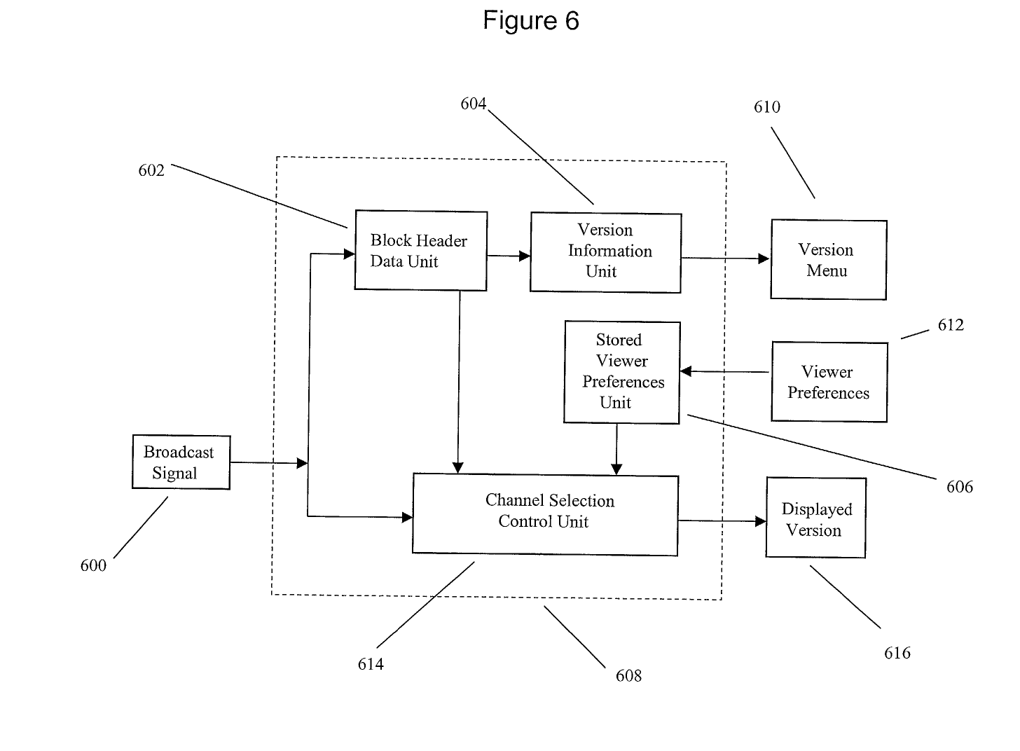

FIG. 6 depicts a digital receiving unit employing stored viewer preferences. Receiving unit 608 is comprised of block header data unit 602, channel selection control unit 614, version information unit 604 and stored viewer preferences unit 606. Broadcast signal 600 is provided to block header data unit 602 and channel selection control unit 614. Block header data unit 602 obtains information from packet headers comprising the digital broadcast and provides version information to version information unit 604 and to channel selection control unit 614. Additionally, although not indicated by arrows in FIG. 6, version information unit 604 may provide version information to channel selection control unit 614. Version information unit 604 may be used to create version menu 610. User preferences 612 are stored in stored user preferences unit 606. Channel selection and control unit 614 processes available version information from block header data unit 602 and stored viewer preferences unit 606 to select and output displayed version 616 that most closely matches viewer preferences.

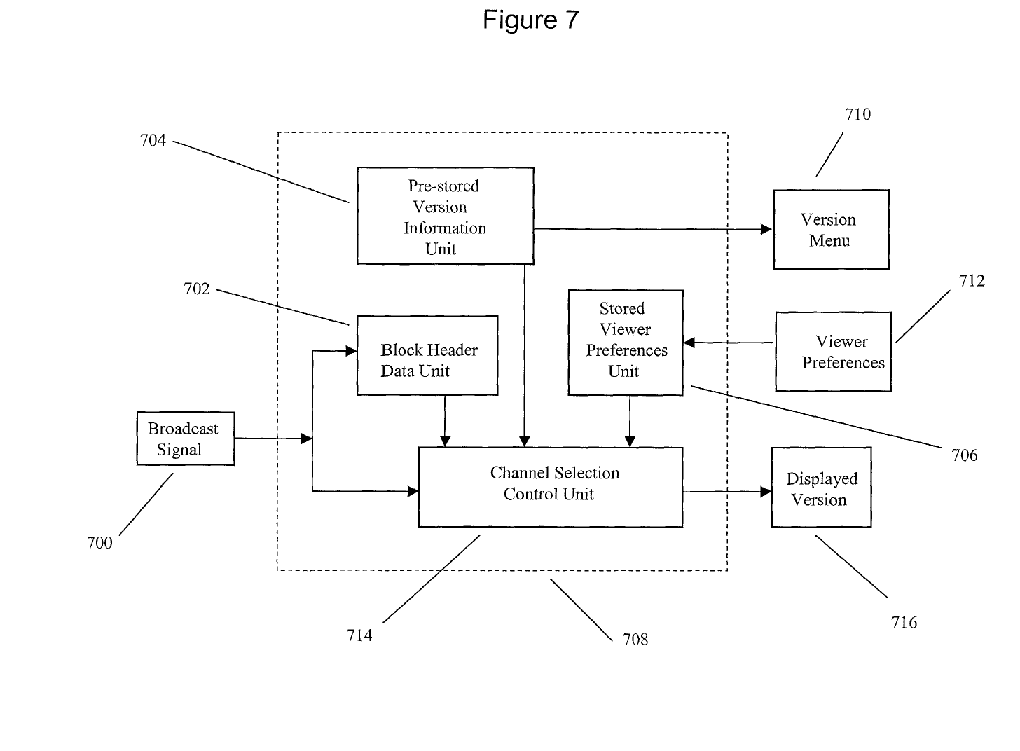

FIG. 7 depicts a digital receiving unit employing pre-stored version information and digital broadcast. Broadcast signal 700 comprises a plurality of channels and is input to channel selection control unit 714 and block header data unit 702. Pre-stored version information unit 704 is loaded with version information prior to transmission of the program or segments of the program. Stored viewer preferences unit 706 contains preferences that may be entered through a remote control, on-screen menu or other method. Pre-stored version information unit 704 maybe used to produce version menu 710 from which a viewer may indicate viewer preferences 712 which then may be stored in stored viewer preferences unit 706. Block header data unit 702 obtains program information from the broadcast signal 700 and presents it to channel selection control unit 714, which then selects and outputs displayed version 716 in response to program information, stored viewer preferences, and pre-stored version information. The architecture of data block header unit 702 is similar to that used in MPEG display processors wherein data blocks contain header information describing the type of data, which may be audio or visual, and the play time of the data block.

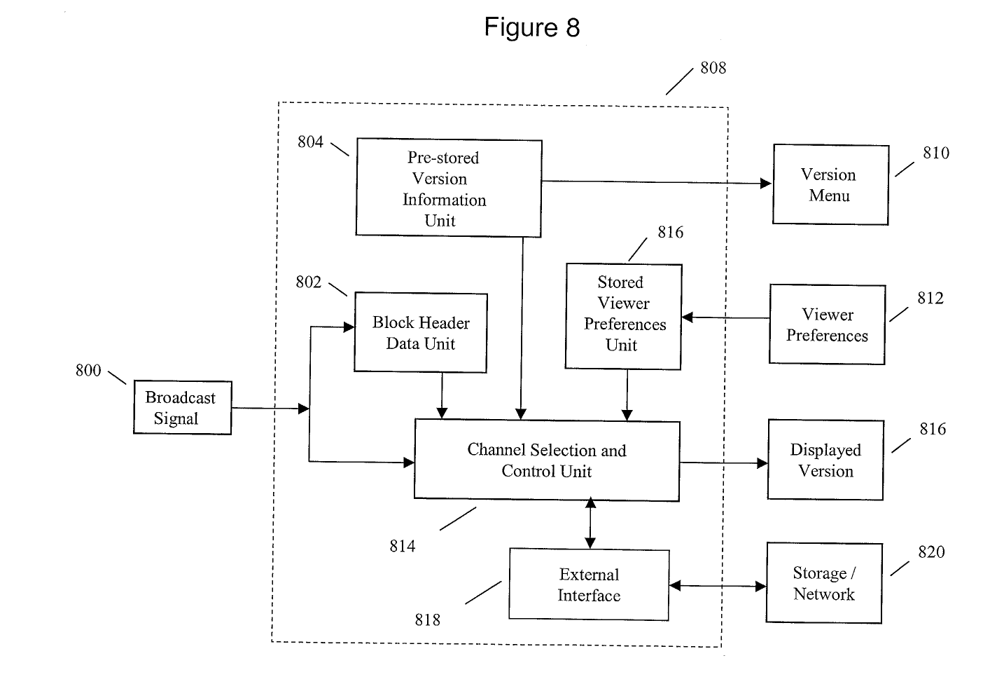

FIG. 8 depicts a digital receiving unit employing an external interface. Receiving unit 808 is comprised of block header data unit 802, channel selection control unit 814, version information unit 804, stored viewer preferences unit 806, and external interface 818. Broadcast signal 800 is provided to block header data unit 802 and channel selection control unit 814. Block header data unit 802 provides version information to version information unit 804 and to channel selection and control unit 814. Version information unit 804 may be employed to create version menu 810. User preferences 812 are stored in stored user preferences unit 806. The use of viewer preferences to select video segments is more fully disclosed in the above referenced patent application, Ser. No. 09/933,928, entitled “iSelect Video”. Channel selection and control unit 814 processes available version information from block header data unit 802 and stored viewer preferences unit 806 to select and output displayed version 816 that most closely matches viewer preferences. External interface 818 may provide a network connection, such as the Internet for example, or may provide a connection to a storage device such as a digital video recorder, hard disk drive, or other storage medium. External interface 818 may be employed to access storage, such as a hard disk drive or digital video recorder, for example, to store a selected version of a program for later viewing, or that may be employed to provide selected segments in conjunction with a broadcast program. Further, external interface 818 may provide a network connection, such as the Internet, for example, that may be employed to access program versions or other information in conjunction with a broadcast. Information may include text, graphics, screen overlays, advertising, audio, or other content that may be rendered in synchrony with a broadcast program.

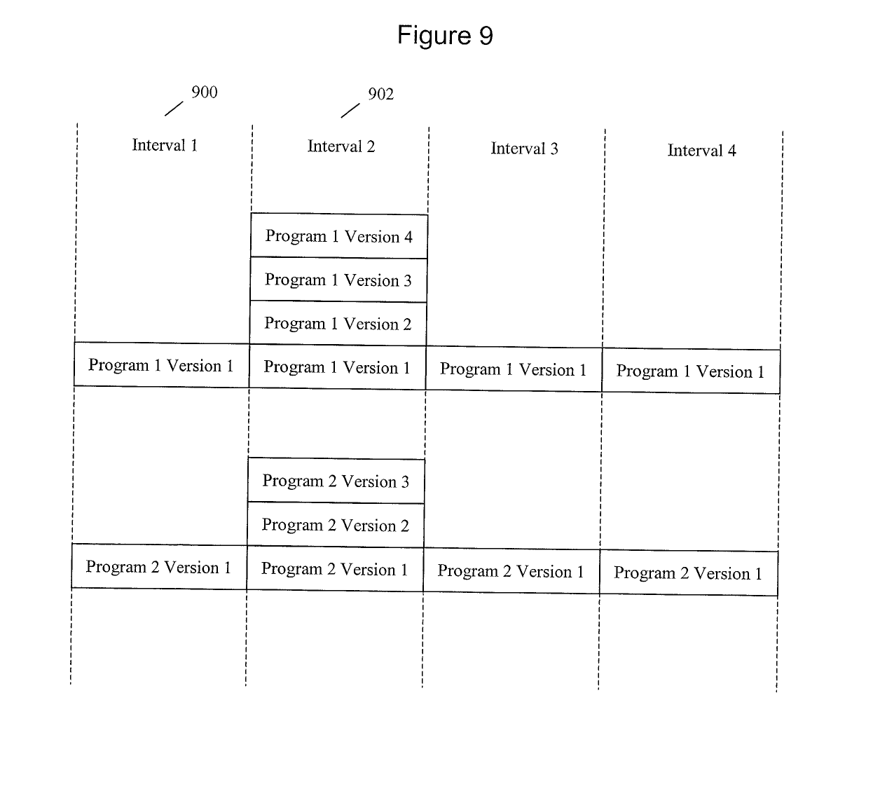

As previously mentioned, digital broadcast may employ a multiple channels per carrier format such that, for example, a 6 MHz analog channel may support 5 simultaneous digital program channels. These channels may be employed to broadcast a plurality of separate programs, or may be employed to broadcast a plurality of versions for one or more programs, as illustrated in FIG. 5. For a program having multiple versions, there may be sequences or scenes for which the audio and video are the same for all versions, such that only one version is broadcast, and there may be other sequences or scenes for which multiple versions are broadcast. When two or more programs, each having multiple versions, are broadcast, there is a possibility that periods of time may exists when a plurality of programs may each have a plurality of versions. FIG. 9 depicts the coincidence of multiple versions for multiple programs. At time interval 1 (label 900), there is one version each for program a and program 2 such that two channels are utilized. At time interval 2 (label 902), there are four versions of program 1 and three versions of program 2, resulting in seven channels being needed to support the simultaneous broadcast of program 1 and program 2. The coincidence of multiple versions of two or more programs may result in the desired utilization of more channels than are available from a single carrier in a MCPC broadcast format. A receiving unit that supports reception and decoding of information on more than one channel could be employed to provide the desired number of channels, however such a receiving unit is more costly than a single channel receiver. The number of channels required to support simultaneous broadcast in a single channel of two or more programs each having multiple versions may be constrained to a predefined number of channels by selecting programs wherein intervals of multiple versions do not coincide in a manner that exceeds the predefined number of channels. In another embodiment, the start of a program or programs may be delayed or scheduled such that intervals of multiple versions do not exceed the number of available channels. In other words, the programs are staggered to limit the number of channels needed to concurrently support broadcast of the versions of each program.

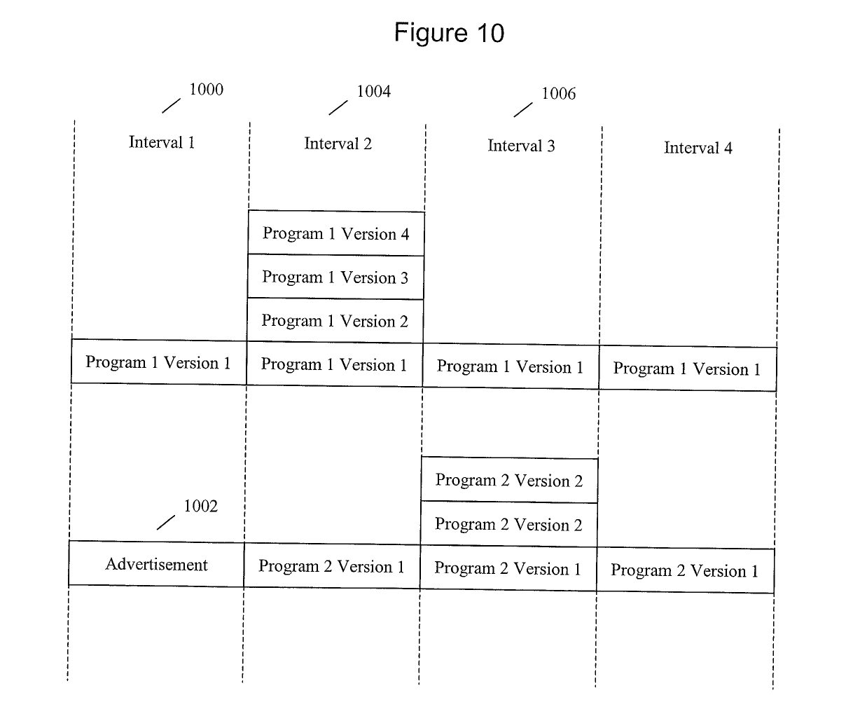

FIG. 10 depicts advertising insertion to constrain the number of channels required to simultaneously broadcast a plurality of programs with multiple versions. FIG. 10 is similar to FIG. 9 in that there are four versions of program 1 at one time interval and three versions of program 2 at another time interval. At time interval 1 (label 1000), advertisement 1002 has been inserted to delay program 2 such that intervals of multiple versions do not coincide. At time interval 2 (label 1004), there are four versions of program 1 and one version of program 2 such that five active channels are employed. At time interval 3 (label 1006), there is one version of program 1 and three versions of program 2 such that four channels are employed. The method of delay illustrated in FIG. 10 may employ advertising, programs shorts, or other content to delay one or more programs. The delay method of FIG. 10 may also be employed to produce intervals where there are multiple versions of two or more programs in the same time interval wherein the number of channels employed does not exceed a predefined number.

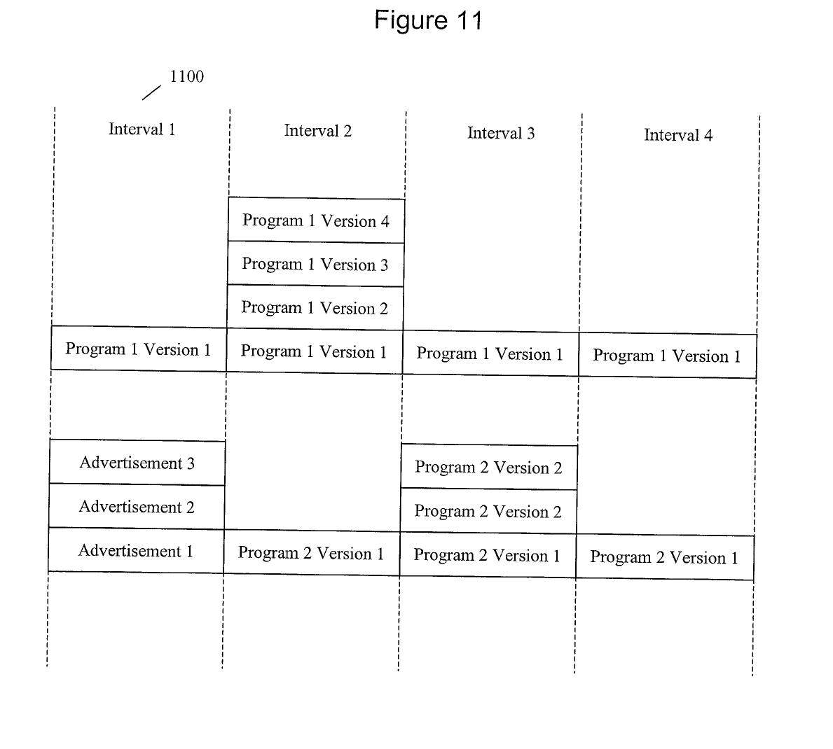

The time alignment of broadcast of multiple programs having multiple versions to limit the number of channels employed may result in time intervals when not all available channels are utilized. FIG. 11 illustrates the utilization of available channels to provide multiple versions of advertising. At time interval 1 (label 1100), there is one version of program 1 and three advertisements. The advertisements may be versions of a single advertisement or may be distinct advertisements. The viewer preference employed to select program versions may be employed to select advertising content. For example, advertisements for toys, diapers, or other products associated with a younger viewing audience, may be shown in conjunction with PG rated programs and advertisements for products targeted to an older audience may be shown in conjunction with R rated programs.

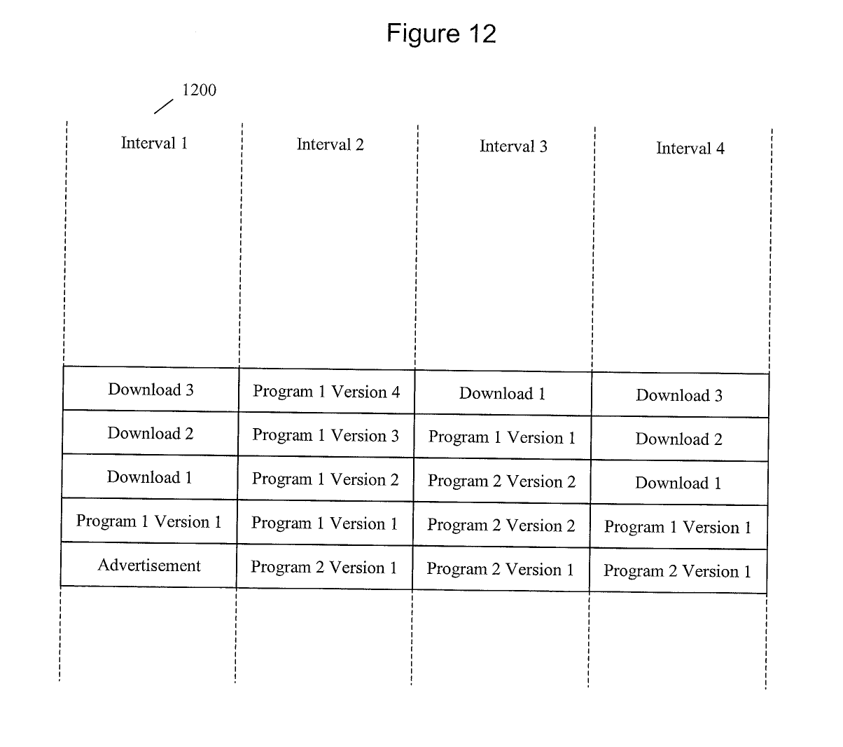

Available channel time intervals may also be employed to download information. FIG. 12 depicts utilization of available channel intervals for downloads. Downloads may comprise enhancements, audio and video segments that may be employed to provide version selection for upcoming broadcasts, or may comprise a program, or multiple versions of a program that may be stored to a recording device for later viewing. For example, the number of time intervals available for downloads in an MCPC format may not be sufficient to support real-time viewing of a program, however, the program may be stored and then later retrieved at a rate that supports real-time video and audio. The storage of download information may also employ viewer preferences such that from multiple versions provided as downloads, only a version corresponding to viewer preference is stored. Downloads may also be employed as a delivery medium for video rentals such that a movie or other program is downloaded in ‘background’ mode and is made available for viewing for some period of time after which the storage is overwritten or erased or playback is inhibited in some manner. The method of downloads may also be used in a manner such that during intervals when programs are of a single version, downloads are employed to store one or more versions to a recording device such that during periods of multiple versions for programs, a version may be rendered from the broadcast stream or from a stored versions, thereby allowing a single analog channel to support a plurality of programs with multiple versions without exceeding the available number of digital channels.

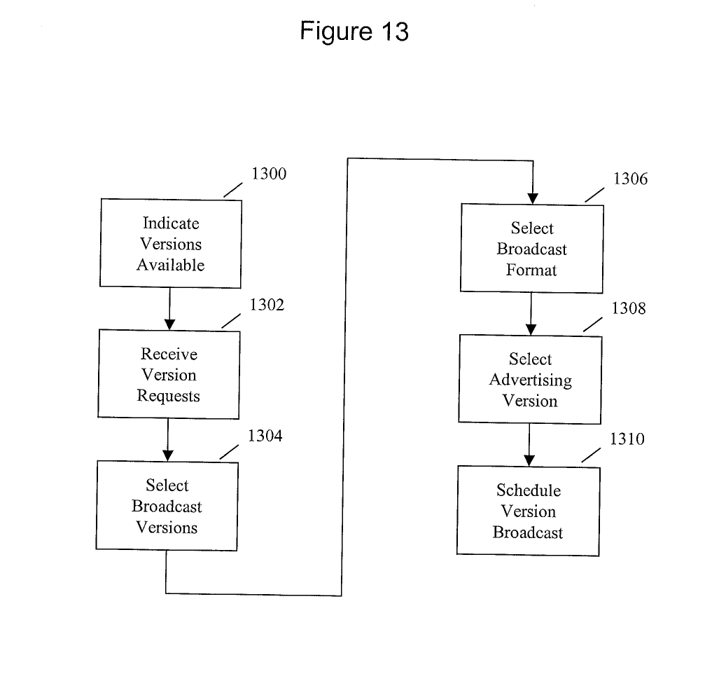

As noted previously, a limited number of digital channels may be encoded into a single analog channel. The number of programs that may be supported simultaneously employing a MCPC format in a single analog channel depends on the number of versions of each program and the coincidence of intervals of multiple versions. In some instances, a broadcaster may choose to limit the number of versions broadcast such that more programs may be broadcast in the channel. The number of versions provided may be based upon viewer requests and available bandwidth. FIG. 13 depicts a method for broadcasting multiple versions of a program. At step 1300, program information is provided to viewers including the versions available for a particular program. Program information may be provided via a menu from which a viewer may select a version. Program information may include the versions available, a description of the versions, the rating of each version, and a reason for each rating. At step 1302, requests for versions are received from viewers. At step 1304, broadcast versions are selected. Such selection may employ frequency of request, possible charges for certain versions, coincidence of multiple versions with other programs broadcast, or other criteria. Some available versions may not be presented if the number of requests, or other metric, does not meet criteria. For example, if only two requests are received for a particular version of a program and thousands of requests are received for other versions, the broadcaster may decide not to broadcast the version with only two requests. The bandwidth that would have been used to transmit the version with only two requests may then be used to broadcast other programs. If the broadcast of a first program having multiple versions coincides with the broadcast of a second program having multiple versions, a broadcaster can employ the number of requests to determine if more versions of the first program shall be broadcast than versions of the second program. This is a simple function of the broadcaster being limited to by the bandwidth to providing only certain versions. An algorithm may be employed to select the most requested versions, highest revenue versions, or other versions in an automatic manner. At step 1306, a broadcast format is selected. Broadcast format may comprise the selection of digital channels on which multiple versions are transmitted, may comprise utilization of the Internet or other network to transmit one or more versions, and may comprise preloading of versions to a storage device associated with a receiving unit. At step 1308, advertising may be associated with versions of a program to be broadcast. At step 1310, broadcast is scheduled. Scheduling may comprise adjustment of program start times, insertion of commercials, or other content such that the number of channels required for display of coincident multiple versions does not exceed a predetermined number of channels.

The present invention may be applied to cable, satellite, terrestrial broadcast, and other broadcast systems and is not limited to any particular architecture or technology. Elements described with respect to the drawings may be implemented in hardware, software, or in combination of hardware and software. The concept of multiple digital channels supported in an analog channel has been employed to illustrate bandwidth utilization. A digital channel may also be viewed as a sequence of packets, with a packet identifier (PID) that may be employed to associate a packet with a particular program and a particular version of a program.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

We claim:

1. A method of broadcasting of a program containing a plurality of versions from a broadcaster to viewers comprising:
broadcasting information from said broadcaster to said viewers indicating that said plurality of versions of said program are available to said viewers;
said broadcaster receiving requests from at least one of said viewers for at least one version of said plurality of versions of said program;
said broadcaster making a decision to broadcast said one version of said plurality of versions of said program based upon said requests; and
said broadcaster broadcasting said one version of said plurality of versions of said program to said one of said viewers.

2. The method of claim 1 further comprising:
said viewer transmitting to said broadcaster a request for said at least one version of said plurality of versions of said program.

3. A method of broadcasting of a program containing a plurality of versions from a broadcaster to viewers comprising:
broadcasting information from said broadcaster to said viewers indicating that said plurality of versions of said program are available to said viewers;
said broadcaster receiving requests from a plurality of said viewers for at least two versions of said plurality of versions of said program;
said broadcaster making a decision to broadcast said two versions of said plurality of versions of said program based upon said requests; and
said broadcaster broadcasting said two versions of said plurality of versions of said program to said viewers.

4. The method of claim 3 further comprising:
said viewer receiving a broadcast comprising said at least two versions of said program;
selecting one version from said at least two versions of said plurality of versions of said program using viewer preference information; and
displaying said one version.

5. The method of claim 4 wherein said viewer preference information is stored in a receiving unit.

6. The method of claim 4 wherein said step of selecting said one version further comprises:
obtaining content information contained in a blanking interval of said program.

7. The method of claim 4 wherein said step of selecting said one version further comprises:
obtaining content information contained in a packet of digital information comprising said program.

8. A method of broadcasting a first program containing multiple versions and a second program containing multiple versions comprising:
determining the time and duration when multiple versions occur for said first program and for said second program;
determining a first maximum number of channels utilized by said first program when said multiple versions occur;
determining a second maximum number of channels utilized by said second program when said multiple versions occur; and
determining a start time for each program such that when said first program employs said first maximum number of channels does not coincide with when said second program employs said second maximum number of channels.

9. A method of broadcasting a first program containing multiple versions and a second program containing multiple versions comprising:
determining the time and duration when multiple versions occur for said first program and for said second program;
determining the maximum number of versions available at one time for said first program and an occurrence of said maximum number of versions for said first program;
determining the maximum number of versions available at one time for said second program and an occurrence of said maximum number of versions for said second program;
determining a start time for each program such that said occurrence of said maximum number of versions for said first program does not coincide with said occurrence of said maximum number of versions for said second program.

10. A method of broadcasting a first program containing multiple versions and a second program containing multiple versions comprising:
determining the time and duration when multiple versions occur for said first program and for said second program;
determining a first maximum number of channels utilized by said first program when said multiple versions occur;
determining a second maximum number of channels utilized by said second program when said multiple versions occur; and
inserting an advertisement in the broadcast stream associated with said first program such that when said first program employs said first maximum number of channels does not coincide with when said second program employs said second maximum number of channels.

11. A method of presenting advertising in conjunction with the broadcast of a program comprising a plurality of versions, the method comprising:
broadcasting said plurality of versions of said program wherein said broadcast includes content information for each version of said plurality of versions of said program;
determining a first characteristic of a first version of said plurality of versions of said program, said first version having first content information;
associating an advertisement with said first characteristic; and
broadcasting said advertisement with said first content information.

12. The method of claim 11 wherein said first content information comprises a rating of the version of the program.

13. The method of claim 11 further comprising:
determining a second characteristic of a second version of said plurality of versions of said program, said second version having second content information;
associating an advertisement with said second characteristic; and
broadcasting said advertisement with said second content information.

14. The method of claim 13 wherein said second content information comprises a rating of the version of the program.

15. A method of presenting advertising in conjunction with the broadcast of a first program comprising a plurality of versions and a second program comprising a plurality of versions, the method comprising:
selecting a time interval to broadcast an advertisement associated with said first program;
determining the number of channels utilized by said plurality of versions of said second program during said time interval;
broadcasting a first advertisement during said time interval; and
broadcasting a second advertisement during said time interval if said number of channels utilized is at least two less than the number of channels available.

16. The method of claim 15 wherein said first advertisement is associated with a first version of said plurality of versions of said first program.

17. The method of claim 15 wherein said second advertisement is associated with a second version of said plurality of versions of said first program.

18. A method of transferring information in conjunction with the broadcast of a first program comprising a plurality of versions and a second program comprising a plurality of versions, the method comprising:
defining a time interval;
determining a first number of channels utilized by said plurality of versions of said first program during said time interval;
determining a second number of channels utilized by said plurality of versions of said second program during said time interval;
comparing the sum of said first number and said second number to a predefined value; and
transferring data during said time interval if said sum is less than the number of channels available.

19. A method of selecting a displayed version of a program containing a plurality of versions comprising:
transferring viewer preference information from a receiving unit to a broadcaster of said program;
storing said viewer preference information in said receiving unit;
receiving a broadcast signal comprising at least two versions of said plurality of versions of said program;
accessing said viewer preference information;
obtaining content information from said program; and
selecting one version of said at least two versions employing said viewer preference information.

20. The method of claim 19 wherein said step of obtaining content information further comprises:
obtaining content information from packet headers contained in a digital broadcast signal.

21. The method of claim 19 further comprising:
transferring updated viewer preference information to said broadcaster;
storing said updated viewer preference information in said receiving unit; and
selecting a new one version of said at least two versions employing said updated viewer preference information.

22. A system for selecting a version of a program from a broadcast comprising a plurality of versions of said program, said system comprising:
a receiving unit that displays a list of said plurality of versions of said program;
a communications unit contained in said receiving unit that transmits a viewer preference indicating one version of said plurality of versions to a broadcaster of said program;
a memory that stores said viewer preference in said receiving unit;
a receiver in said receiving unit that receives a broadcast program comprising at least two versions of said plurality of versions of said program; and
a selection unit in said receiving unit that selects one version from said at least two versions of said program employing said viewer preference and displays said one version.
